(19) United States
(12) Patent Application Publication
(10) Pub. No.: US 2020/0155408 A1
(43) Pub. Date: May 21, 2020

(54) ERGONOMIC WALKER

(71) Applicant: Clipsy, LLC, Henderson, NV (US)

(72) Inventor: Farvardin Fathi, Henderson, NV (US)

(21) Appl. No.: 16/683,204

(22) Filed: Nov. 13, 2019

Related U.S. Application Data
(60) Provisional application No. 62/767,134, filed on Nov. 14, 2018.

(51) Int. Cl. A61H 3/04

(52) U.S. Cl. CPC A61H 3/04; A61H 2003/006

(57) ABSTRACT

The present disclosure provides an ergonomic walker that can allow a user to walk upright in comfort and with good posture. The ergonomic walker can be adjusted to a comfortable height, and allows the user to rest the user's forearms in cradles and grasp ergonomically positioned handgrips. The walker is lightweight and can be easily collapsed for storage.

### RELATED APPLICATION

This application claims the benefit of U.S. Provisional Application Ser. No. 62/767,134, filed Nov. 14, 2018, entitled ERGONOMIC WALKER, the entire disclosure of which is herein incorporated by reference.

### FIELD OF THE INVENTION

This invention relates to therapeutic and orthopedic equipment, and more particularly to walkers used by individuals with impaired mobility.

### BACKGROUND OF THE INVENTION

Traditional walkers often require a user to hunch over to hold a short and heavy structure. The heavy and short walker structure must be first moved out in front of the user, and then the user can walk towards the structure, stop, and again re-move the structure out in front of the user so that the user can put weight on it while moving towards the walker structure. This requires the user to alternate between moving the structure and walking towards the structure. This also requires the user, who is often hunched over the walker, to lift the walker, or partially lift the walker using the lower back to move the walker structure out in front of the user. This traditional walker requires the user to lift the structure with the user's lower back each time the user prepares to take a step. A traditional walker also requires the user to support all of the user's weight on the user's wrists as the user supports each step by holding onto the short walker structure to avoid falling. This traditional walker allows limited mobility due to the need to move the walker between steps, and forces the user into poor posture.

### SUMMARY OF THE INVENTION

The present disclosure overcomes disadvantages of the prior art by providing an adjustable walker that allows users of different heights to stand and walk upright in an erect position, and allows users to walk freely with a walker that moves with the user as the user steps. Various embodiments of the present disclosure provide a lightweight and adjustable walker that can be adjusted in at least four directions so that the walker can be customized to each user, their posture, etc. The walker can roll freely on three or more wheels while supporting the weight of a user over the wheels. The walker can provide a convenient seat with adjustable armrests, and the walker can include an automatic brake that can lock the walker in place while the user is pushing on the walker to rise from a seated position to a standing position.

In an illustrative embodiment, an ergonomic walker can have a front leg with a wheel, at least one support plate, two rear supports with wheels, the rear supports rotatably affixed to the at least one support plate, and two armrests rotatably affixed to the at least one support. The front leg can include a front telescoping stem and a height adjustment control. The at least one support plate can include an upper support plate and a lower support plate, and wherein the two armrests can be rotatably affixed to the upper support plate, and the two rear supports can be rotatably affixed to the lower support plate. The front telescoping stem can be between the upper support plate and the lower support plate. The front telescoping stem can be weight bearing between the upper support plate and the lower support plate. The walker can include one or more stabilizing telescoping stems between the upper support plate and the lower support plate. The one or more stabilizing telescoping stems can include two stabilizing telescoping stems, and wherein the stabilizing telescoping stems can connect between the armrests and the rear support. The height adjustment control can include a knob and a threaded stalk, and the front telescoping stem can include an upper stem and a lower stem, and wherein the lower stem can be threaded on the inner surface, so that the threaded stalk can engage with the threads of the lower stem, so that the height of the armrest can be adjusted by twisting the knob of the front leg. The front leg includes a brake on the bottom of the front leg, and the front leg includes a rod attached to the front wheel, the rod moving within a cavity of the front leg, and a spring within the cavity that biases the wheel away from the brake. The walker can include a parking brake that can have a hook at the top end, and the parking brake can pass through the lower support plate so that the bottom end of the parking brake can be off the ground if the hook is turned in a first direction, and the bottom end of the parking brake can be engaged with the ground when the hook is turned in a second direction. Each armrest can include a cradle adapted for a user to rest forearms on the cradle, and a handgrip adapted for the user to hold by hand. Each rear support includes a seat holder and a lower handle. Each armrest includes a support rail, the support rail configured to engage with a lip of the seat, and wherein the seat can be removably affixed to the seat holders as a seat, and can be removably affixed to the support rails as a shelf.

In an embodiment, an ergonomic walker can include at least one front leg having a wheel, two rear supports having rear wheels, one or more supports extending between the legs for structural rigidity, and two adjustable armrests above the walker, the armrests adjustably extendable upwards from a support to different heights above the wheels. The armrests can be on stems that are pivotably affixed to the support, so that the armrests can pivot to different angles relative to each other. Each of the armrests can include a cradle and a handgrip. The walker can have a wheel brake with a spring that biases the wheel away from the brake until a predetermined amount of pressure is applied to push the wheel and the brake into engagement.

### BRIEF DESCRIPTION OF THE DRAWINGS

The invention description below refers to the accompanying drawings, of which:

FIG. 1 is a perspective view of an ergonomic walker, according to an illustrative embodiment;

FIG. 2A is a perspective view of an armrest height lock, according to an illustrative embodiment;

FIG. 2B is an exploded view of an armrest height lock, according to an illustrative embodiment;

FIG. 2C is a partially transparent view of the armrest height lock shown in a locked position;

FIG. 2D is a partially transparent view of the armrest height lock shown in an unlocked position;

FIG. 3A is a detailed view of an armrest that is adjustable in three directions, according to an illustrative embodiment;

FIG. 3B is an exploded view of armrest with armrest position locks, according to an illustrative embodiment;

FIG. 3C is a partially transparent perspective view of a handlebar lock, according to an illustrative embodiment;

FIG. 3D is a cross section view of a handlebar lock taken through the locking clasp, according to an illustrative embodiment;

FIG. 4 is a perspective view of a user walking with the walker, according to an illustrative embodiment;

FIG. 5A is a perspective view of a walker in a standing conformation with the seat in a stowed position, according to an illustrative embodiment;

FIG. 5B is a perspective view of the walker in an intermediate conformation with the seat in an intermediate position, according to an illustrative embodiment;

FIG. 5C is a perspective view of the walker in a seating conformation with the seat in the seating position, according to an illustrative embodiment;

FIG. 5D is a rear perspective view of the walker with the seat in the seating position, according to an illustrative embodiment;

FIG. 6A is a perspective view of a user seated on the walker, according to an illustrative embodiment;

FIG. 6B is a diagram of a seating position of a user while seated on the walker, according to an illustrative embodiment;

FIG. 7A is an exploded view showing the components of a rear wheel lock, according to an illustrative embodiment;

FIG. 7B is partially transparent rear view of the wheel brake in an unlocked position;

FIG. 7C is a partially transparent rear view of the wheel brake in a locked position;

FIG. 7D is a perspective view of a manual wheel lock, according to an illustrative embodiment;

FIG. 8A is a perspective view of a walker in a deployed conformation, according to an illustrative embodiment;

FIG. 8B is a perspective view of a walker in a partially collapsed conformation, according to an illustrative embodiment;

FIG. 8C is a perspective view of a walker in a fully collapsed conformation, according to an illustrative embodiment;

FIG. 8D is a front view of a walker in a fully collapsed conformation, according to an illustrative embodiment;

FIG. 9A is a rear view of the bottom of a seat in the stowed position showing storage compartments, according to an illustrative embodiment;

FIG. 9B is a rear view of the bottom of a seat in the stowed position showing storage compartments with closures, according to an illustrative embodiments;

FIG. 10 is a side view showing the walker with an optional straight handlebar, according to an illustrative embodiment;

FIG. 11 is a rear view of a walker showing armrests from the perspective of a user, according to an illustrative embodiment;

FIG. 12A is a rear view of a walker showing an optional phone holder, according to an illustrative embodiment;

FIG. 12B is a rear view of a walker showing an optional bottle holder, according to an illustrative embodiment;

FIG. 12C is a rear view of a walker showing an optional bell, according to an illustrative embodiment;

FIG. 12D is a rear view of a walker showing an optional rear view mirror, according to an illustrative embodiment;

FIG. 12E is a rear view of a walker showing an optional headlamp, according to an illustrative embodiment;

FIG. 12F is a rear view of a walker showing optional tail lights, according to an illustrative embodiment;

FIGS. 13A-13G are front, back, left, right, top, bottom, and perspective views of a walker in a collapsed conformation, according to an illustrative embodiment;

FIGS. 14A-14G are front, back, left, right, top, bottom, and perspective views of a walker in a seating conformation, according to an illustrative embodiment;

FIGS. 15A-15F are front, back, left, right, top, and bottom views of a walker in a standing conformation, according to an illustrative embodiment;

FIG. 16A is a perspective view of a walker with a telescoping front leg, according to an embodiment;

FIG. 16B is an exploded perspective view of the walker of FIG. 16A, according to an illustrative embodiment;

FIG. 17A is a partially cut away view of a walker with a telescoping front leg, showing the inner workings of the telescoping front leg and with dimensions, according to an illustrative embodiment;

FIG. 17B is an enlarged view of the front wheel and braking mechanism shown in FIG. 17A, according to an illustrative embodiment;

FIG. 18A is a top perspective view of a seat shown in a storage conformation, according to an illustrative embodiment;

FIG. 18B is an exploded bottom perspective view of the seat of FIG. 18A, according to an illustrative embodiment;

FIG. 19 is a top view of the walker with a telescoping front leg, according to an illustrative embodiment;

FIG. 20 is a perspective view of the walker shown in a storage conformation, according to an illustrative embodiment;

FIG. 21 is a top view of the walker shown in a storage conformation with dimensions, according to an illustrative embodiment;

FIG. 22 is a front view of a walker shown in a storage conformation with dimensions, according to an illustrative embodiment; and

FIG. 23 is a partially cut away view of a front leg and front wheel, showing the inner workings, according to an illustrative embodiment.

### DETAILED DESCRIPTION

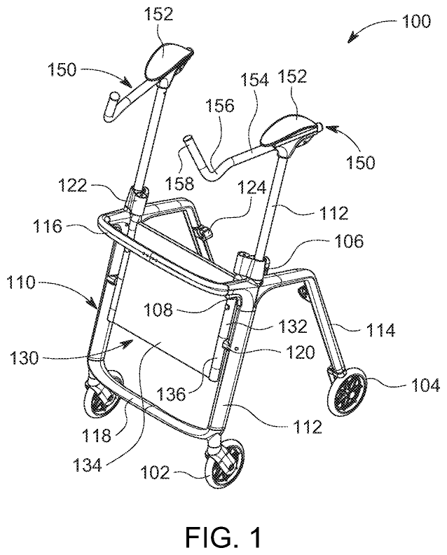

FIG. 1 is a perspective view of an ergonomic walker, according to an illustrative embodiment. A walker 100 can have a frame 110, a seat 130, and an armrest 150. Frame 110 can have one or more front legs 112, rear supports 114, a backrest 116, and one or more support bars 118 that can extend between the front legs 112 and can add structural rigidity to the walker 100. The seat 130 can have side rails 132 that can support a seating platform 134. The seat 130 is shown in a stowed position in FIG. 1. Side rails 132 can have grooves 136 that can engage with and slide along seat support pegs 120 on the frame 110. Side rails 132 can have a clip end region 138 that can engage with clips to retain the seat 130 in the stowed position as shown in FIG. 1, or the seating position, described more fully below. The frame can have stowage clips 122 that can retain the seat in the stowed position so that it is out of the way as a user walks with the walker. The frame can have seating clips 124 that can hold the seat 130 in the seating position and can support a portion of the weight of the user. The walker can have front wheels 102 at the base of the frame 110 that can be swiveling wheels or casters. The walker can have rear wheels 104 on the rear supports 114. Rear wheels 104 can have a braking system, explained more fully below. In various embodiments, front wheels 102 can be approximately 8 inch wheels, and the rear wheels 104 can be approximately 6 inch wheels. The walker can have a folding button 108 that can allow the user to fold the rear supports 114 inward to reduce the size of the walker 100 for ease of transport.

Armrest 150 can have a cradle 152 and a handlebar 154. Handlebar 154 can have a bag hook 156 and a handgrip 158. A user can rest forearms and/or elbows in the cradles 132 while holding the handgrip 158. The user can suspend a purse or other bag from the bag hook 156 while walking, and the bag will be suspended in front of the user's hand and away from the user's legs so that the bag is conveniently accessible while not posing a tripping hazard to the user. The armrest 150 can have a telescoping stem 112. Telescoping stem 112 can extend in and out of the frame 110 to accommodate users of different heights. A walker 100 can have an armrest height lock 106 that can allow a user to selectively adjust the height of the armrest 150.

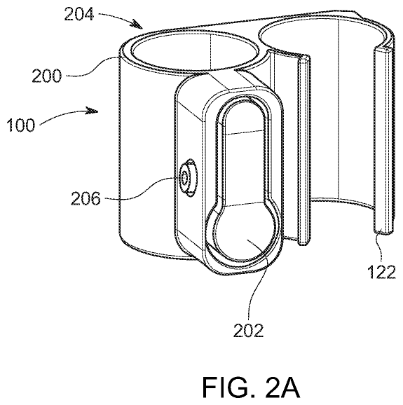

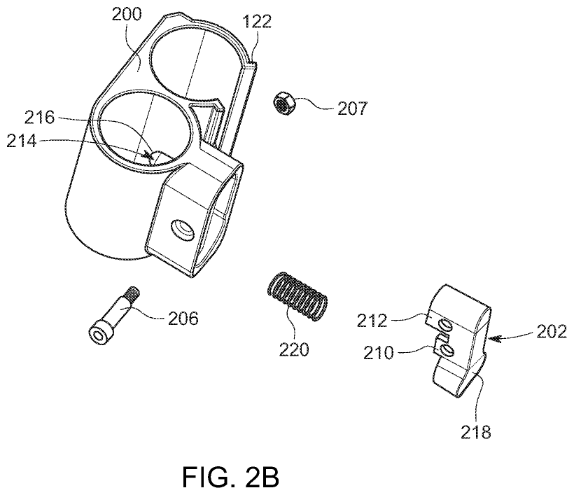

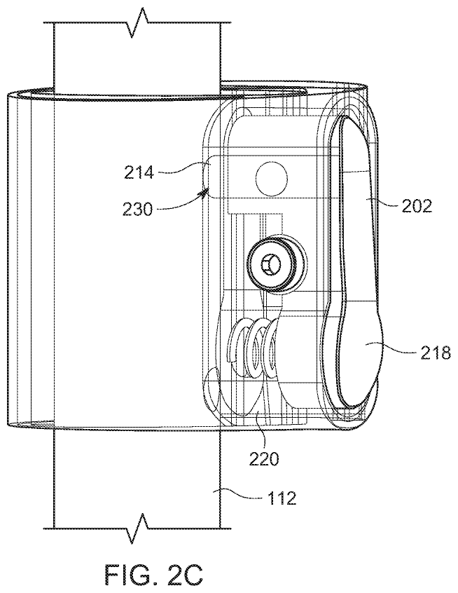

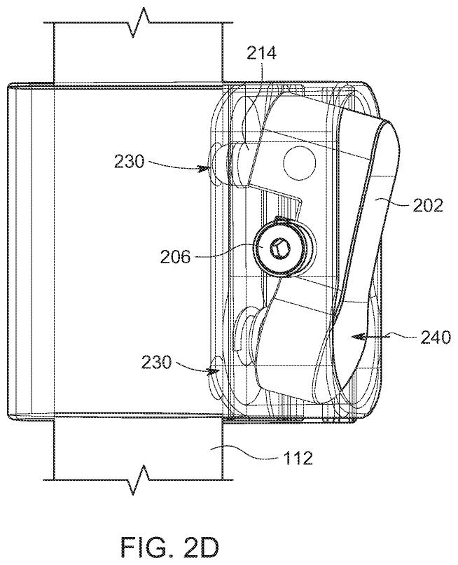

FIG. 2A is a perspective view of an armrest height lock, according to an illustrative embodiment. An armrest height lock 106 can have a lock housing 200, a height adjust control 202, and a sleeve 204 that can house the telescoping stem. In an embodiment, the height adjust control can be a height adjust button. The stowage clips 122 can be connected to, or part of, the lock housing 200. The armrest height lock can house the telescoping stem and allow the telescoping stem to selectively slide through the sleeve. The height adjust button 202 can have a pin or bolt 206 so that the button 202 can pivot within the lock housing 200.

FIG. 2B is an exploded view of an armrest height lock, according to an illustrative embodiment. The height adjust button 202 can have a first hub 210 that can allow bolt 206 to pass through the button 202, so that the button 202 can pivot on the bolt 206 (with nut 207). The button 202 can have a second hub 212 that can allow the button 202 to engage with a locking pin 214. Locking pin 214 can have a distal end 216 that can engage with holes or notches in the telescoping stem, and locking pin 214 can have proximal tabs that can engage within the second hubs 212, so that the locking pin 214 can pivot within the second hubs 212. The button 202 can have a push area 218, and a compression spring 220 can bias the push area outwards so that the locking pin 214 is biased into engagement with the notches of the telescoping stem.

FIG. 2C is a partially transparent view of the armrest height lock shown in a locked position. In FIG. 2C, the compression spring 220 has biased the push area 218 outwards, and the height adjust button 202 is pivoted so that the locking pin 214 is engaged with a notch 230 of the telescoping stem 112. FIG. 2D is a partially transparent view of the armrest height lock shown in an unlocked position. When a user pushes in on the push area 218 with force along arrow 240, the button 202 pivots on the bolt 206 into the unlocked position. In the unlocked position, the locking pin 214 has been pulled out of engagement with the notch 230 of the telescoping stem 112.

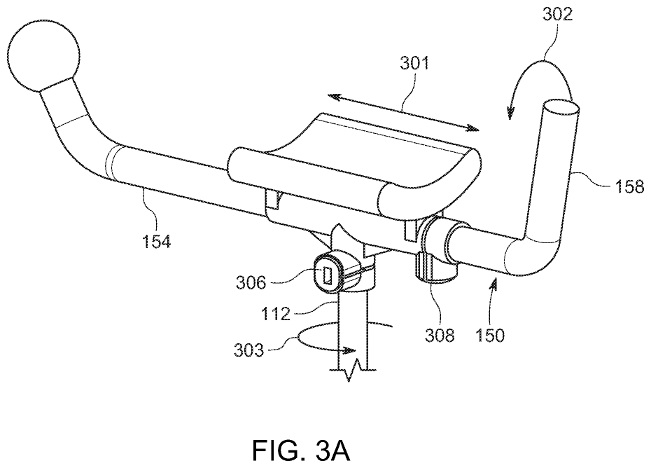

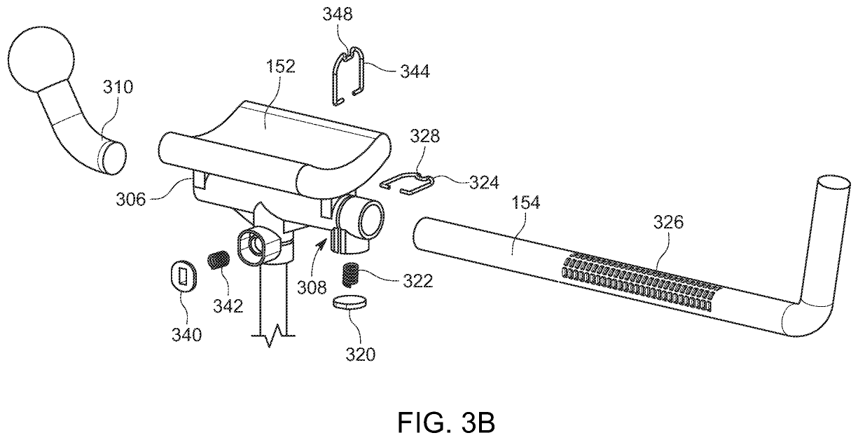

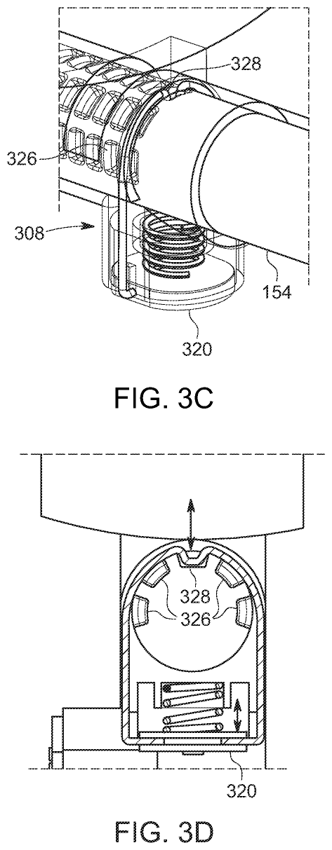

FIG. 3A is a detailed view of an armrest that is adjustable in three directions, according to an illustrative embodiment. The handlebar 154 can slide back and forth along arrow 301. A user can position the handgrip 158 forward or backward along arrow 301 to place the handgrip 158 in a position that allows the user to have a desired posture, and to walk with a desired center of gravity relative to the walker. The handgrip 158 can rotate along arrow 302. A user can rotate the handlebar 154 so that the handgrip 158 is in a position that allows the user to grip the handgrip 158 while the user's wrists are in a comfortable and ergonomic position. The armrest 150 can swivel on the telescoping stem 112 around arrow 303. The user can swivel the armrest 150 into a position that allows the user to rest comfortably on the armrest 150 with the user's hands on the handgrips 158. The armrest can have position locks that can include a swivel lock 306, and a handlebar lock 308, explained more fully below.

The handlebar 154 can include a standing aid 310 at a proximal end of the handlebar. Standing aid 310 can have a knob 312 at the end of a stem 314 that can be angled upwards. Standing aid 310 can be removable from the handlebar 154.

FIG. 3B is an exploded view of armrest with armrest position locks, according to an illustrative embodiment. The position locks can be integrated in and/or attached to the cradle 152. A handlebar lock 308 can have a push button 320, a compression spring 322, and a locking clasp 324. The locking clasp can be connected to the button 320, so that pushing in on the button 320 also pushes in on the locking clasp 324. The compression spring 322 can bias the push button 320 outward so that the locking clasp is also biased in the same direction as the button 320. The handlebar 154 can have divots 326 that can be arranged along a length of the handlebar 152 and around at least a portion of the circumference of the handlebar 152. The locking clasp 324 can have a tooth 328 that can engage with a divot 326.

FIG. 3C is a partially transparent perspective view of a handlebar lock, according to an illustrative embodiment. A user can unlock the handlebar 154 by pressing the button 320. Pressing the button 320 causes the tooth 328 of the locking clasp 324 to disengage from the divot 326 to unlock the handlebar lock 308. When the handlebar lock 308 is unlocked, the user can adjust the handlebar 154 in two directions. When the handlebar lock is unlocked the user can slide the handlebar 154 back and forth, and can rotate the handlebar 154 to change the angle of the handgrip. The user can position the handlebar 154 side to side and rotationally, and can then release the button 320.

FIG. 3D is a cross section view of a handlebar lock taken through the locking clasp, according to an illustrative embodiment. When the button is released, the tooth 328 can engage with the nearest divot 326. The sides of the tooth 328 and/or divots 326 can be angled so that the tooth 328 can easily slide into the nearest divot 326 to secure the handlebar 154 in place. The handlebar lock can provide physical and/or audio feedback to the user when the tooth 328 engages with a divot 326, so that the user knows that the arms have been locked in place and can support the user. The user can unlock the handlebar lock to move in two directions with the push of a single button 320 and a twist, push, and/or pull of the handlebar 154.

Turning back to FIG. 3B, the swivel lock 306 can also have a push button 340, a compression spring 342, and a locking clasp 344. The locking clasp 344 can have a tooth 348 that can engage with divots (not shown). The divots can be located around the circumference of the telescoping stem 112, so that the armrest 150 can swivel around the stem 112 while the button in held in, and the armrest can be prevented from swiveling when the user releases the button so that the tooth 348 can engage with the nearest divot to lock the armrest.

In various embodiments, the armrest height adjust lock 106 can also be the armrest swivel lock 306, so that the user can unlock the height and swivel of the armrest with a single button. In such embodiments, the combined armrest height adjust lock and armrest swivel lock can have mechanisms and functionality similar to the handlebar lock 308.

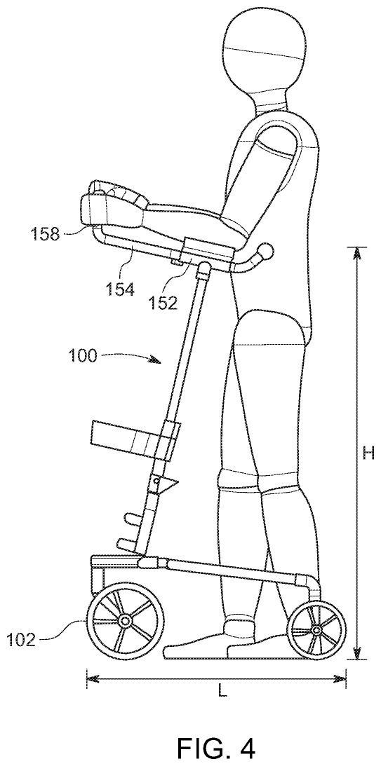

FIG. 4 is a perspective view of a user walking with the walker, according to an illustrative embodiment. A user's hands can be positioned over the front wheels 102 or can extend slightly out in front of the front wheels 102. The user's elbows and/or forearms can rest in the cradle 152. The walker 100 can be adjusted so that the user can stand and walk erect with good posture. The cradle 152 can be at an optimal height to support the weight of the user while the user is walking upright, and the handlebars 154 can be extended so that the handgrips 158 are at a comfortable angle and at a comfortable distance from the cradle 152. The walker can have a length L of approximately 27 inches. The user can walk comfortably while also keeping the user's center of gravity within the walker length L, and the user's feet can be easily kept within the walker length L, as shown in FIG. 4. As the user leans onto the cradles 152 and holding the handgrips 158, a majority of the user's weight is distributed over the front wheels. The walker can have an adjustable height H from the cradle to the floor that can be in a range between approximately 30 inches and 44 inches, so that the walker can allow users of various heights to walk upright.

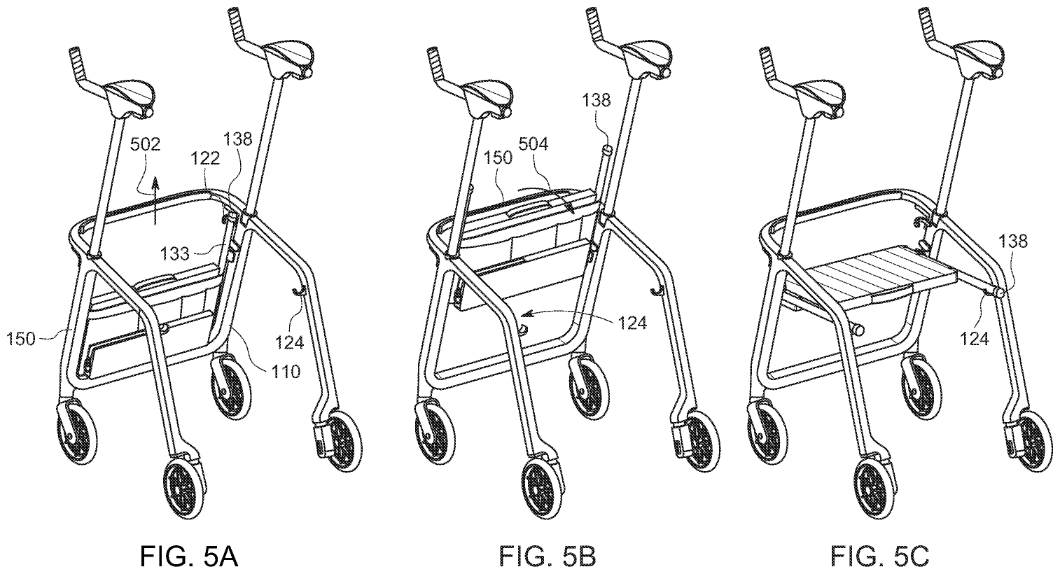

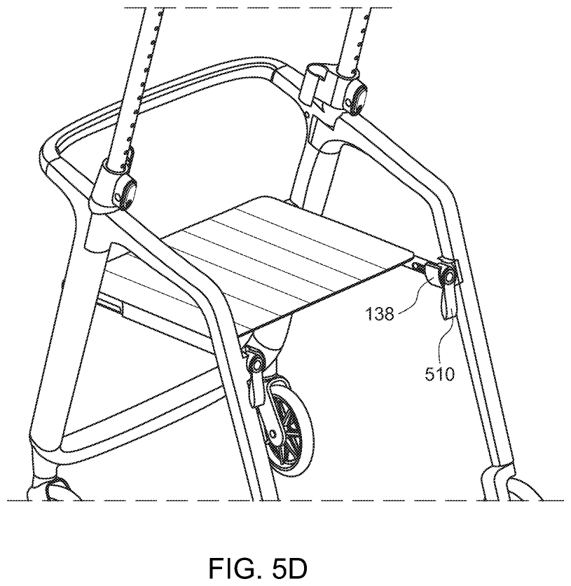

FIG. 5A is a perspective view of a walker in a standing conformation with the seat in a stowed position, according to an illustrative embodiment. A user can begin to convert the walker into a seating conformation by unclipping the clip end regions 138 from the stowage clips 122, and pulling upward on the seat 130 along arrow 502. The side rails can slide along the frame 110 from the stowed position to an intermediate position. FIG. 5B is a perspective view of the walker in an intermediate conformation with the seat in an intermediate position, according to an illustrative embodiment. In the intermediate position, the clip end regions 138 are not engaged with any clips. The user can continue to convert the walker into a seating conformation by rotating the seat 150 downward along arrow 504. FIG. 5C is a perspective view of the walker in a seating conformation with the seat in the seating position, according to an illustrative embodiment. The clip end regions 158 can be supported by the seating clips 124 that can support the seat and retain it in the seating position. FIG. 5D is a rear perspective view of the walker with the seat in the seating position, according to an illustrative embodiment. Clip end regions 158 can have loops or handles 510 to assist a user in moving the seat between the stowed position and the seating position.

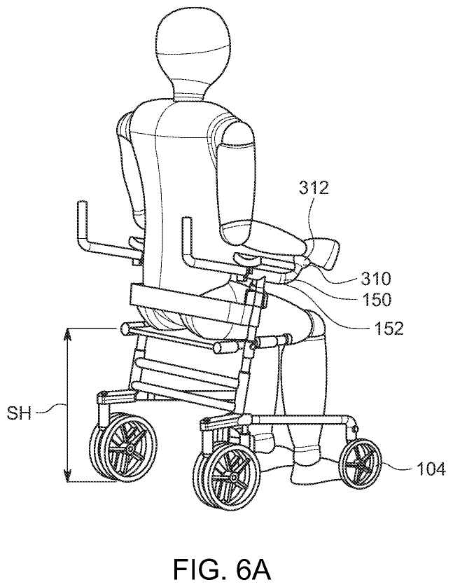

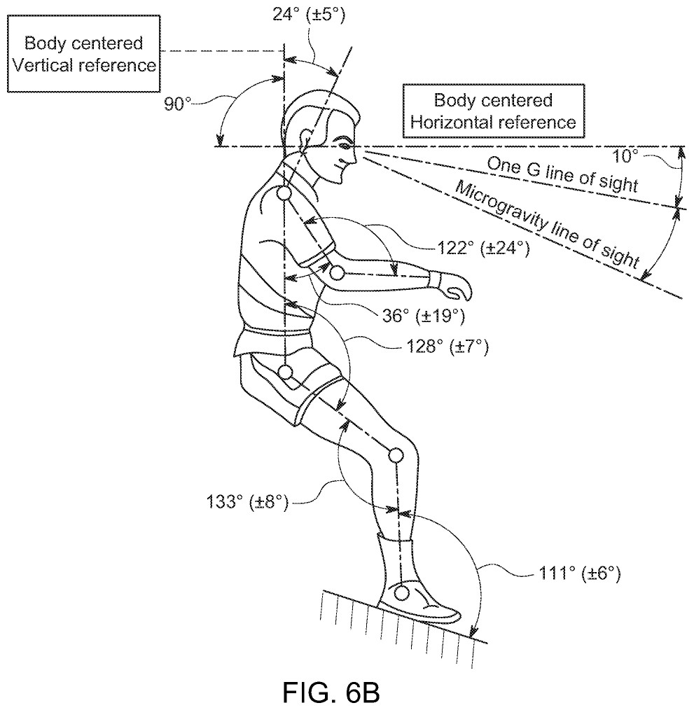

FIG. 6A is a perspective view of a user seated on the walker, according to an illustrative embodiment. The user can lower the armrest 150 into a seating position so that the user can comfortably rest elbows and/or forearms in the cradle 152. A user can also use the structure of the walker to help the user to stand up. A user can hold onto the standing aid 310 that can include knob 312, and can push himself or herself upwards into a standing position. In various embodiments, the user can hold onto the rear supports 114 and can push himself or herself upwards into a standing position using the rear supports 114. The walker 100 can have rear wheel locks that can automatically lock the rear wheels 104 when the user is using the walker as a support to help the user into a standing position. The rear wheel locks can prevent the walker from rolling away or out from underneath the user as the user is pushing down on the walker to reach a standing position. The seat can have a seat height SH that can be approximately 18 inches to approximately 20 inches off of the ground.

FIG. 6B is a diagram of a seating position of a user while seated on the walker, according to an illustrative embodiment. The seat can have a seat height that can be approximately 18 inches off of the ground, and the user can be seated in a neutral body posture with the user's knees positioned below the hip socket, and the user's feet on the ground.

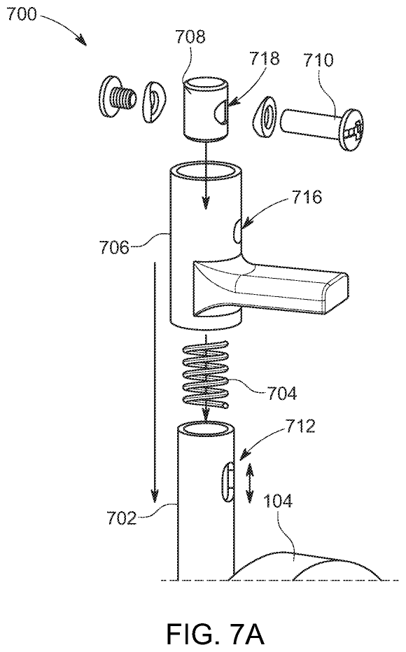

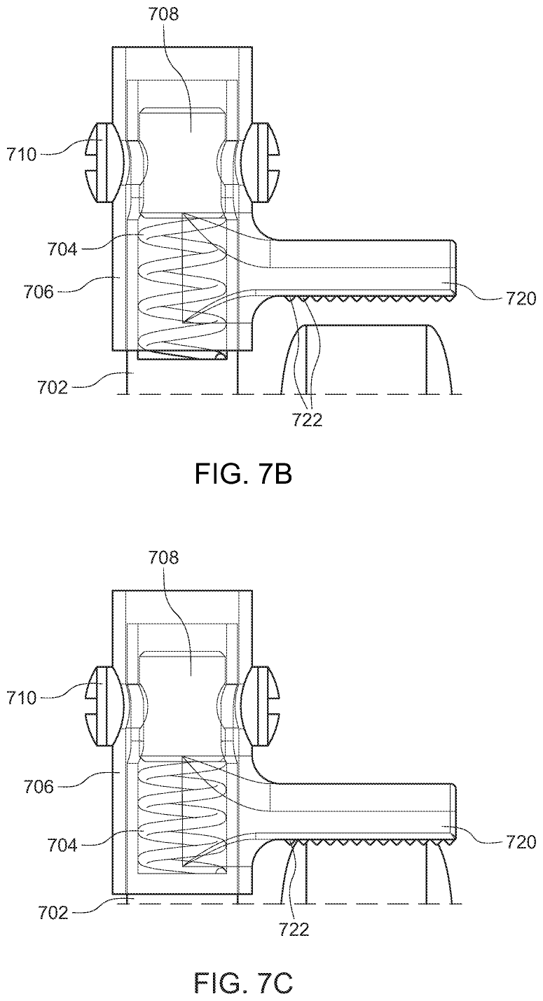

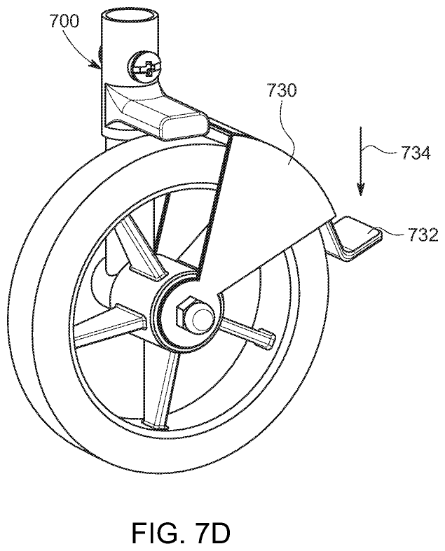

As a user pushes down on the walker to rise from a seated position to a standing position, the rear wheels can lock automatically without the user needing to manually engage a wheel lock. The downward force of the user onto the rear of the walker can press a wheel lock into engagement with the rear wheel 104. FIG. 7A is an exploded view showing the components of a rear wheel lock, according to an illustrative embodiment. A rear wheel lock 700 can have a wheel stem 702, a compression spring 704, a sliding brake 706, a spring support 708, and a pin or bolt 710. The wheel stem 702 can have an extended bolt slot 712, the sliding break 706 can have a bolt hole 716, and the spring support 708 can have a bolt hole 718. The sliding brake can have a brake pad 720 that can be pressed into engagement with the rear wheel 104 to hold the rear wheel secure.

The sliding brake 706 can be slid over the wheel stem 702, and the spring support 708 can be slid into the wheel stem 702 on top of the compression spring 704. The bolt 710 can pass through the bolt slot 712 and the bolt holes 716 and 718 to hold the components together. When the components are held together with the compression spring 704, the compression spring 704 is compressed. FIG. 7B is partially transparent rear view of the wheel brake in an unlocked position. The spring 704 can push upwards on the spring support 708, which can transfer the upward force through the bolt 710 to the sliding brake 706. The compression spring 704 biases the sliding brake 706 away from the rear wheel 104. As the user pushes down on the frame of the walker, the user's weight is transferred to the sliding brake 706, thereby pushing the sliding brake downward onto the wheel and locking the wheel in place. The sliding brake can have knurls or spikes 722 on the brake pad 720 to help lock the rear wheel 104 in place and prevent movement of the walker as the user pushes upwards into a standing position. FIG. 7C is a partially transparent rear view of the wheel brake in a locked position. As long as the user is putting weight on the rear of the walker, either by siting or pushing upwards to stand, the walker will remain locked in place. Because the majority of the user's weight can be positioned over the front wheels while the user is walking, the rear brake is not engaged during walking. The spring 704 can also provide suspension for the walker, allowing the frame to absorb bumps from uneven terrain without engaging the brake unless the user puts the majority of the user's weight over the rear wheels.

FIG. 7D is a perspective view of a manual wheel lock, according to an illustrative embodiment. In addition to the automatic wheel lock 700, a walker can have a manual wheel lock 730 that can allow the user to selectively lock the wheel so that the walker can remain locked in place, without the need for the user to put weight over the rear wheels. The user can engage the lock by pressing downwards on the lock tab 732 along arrow 734, and can unlock the manual wheel lock by pulling upwards on the lock tab 732.

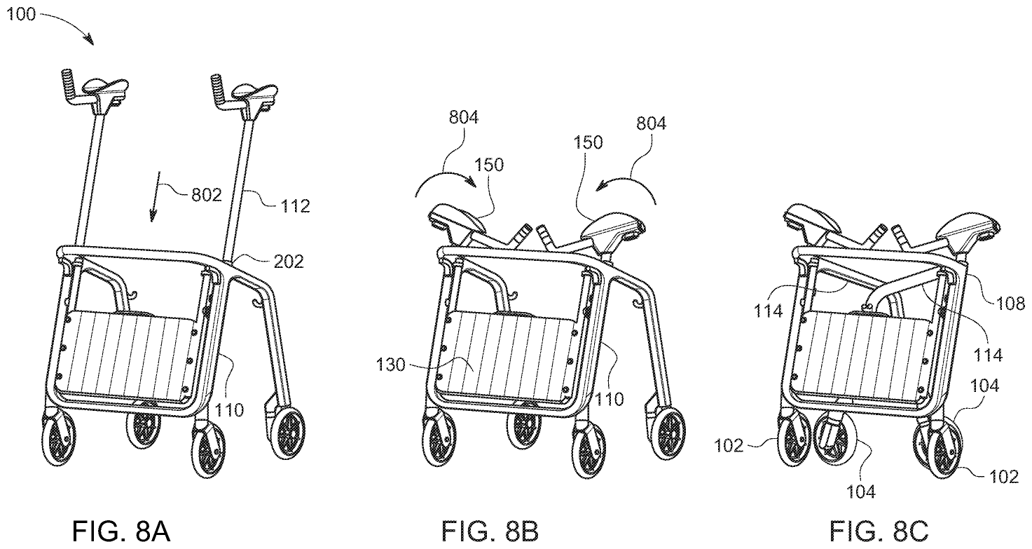

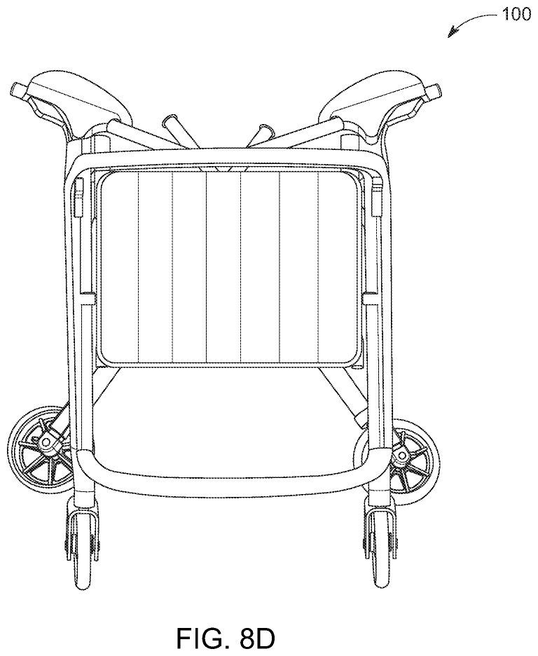

FIG. 8A is a perspective view of a walker in a deployed conformation, according to an illustrative embodiment. A user can quickly collapse the walker 100 to be stored in a trunk or other small area. A user can press the height adjust button 202 to slide the telescoping stems 112 downward in the direction of arrow 802 and into the frame 110. FIG. 8B is a perspective view of a walker in a partially collapsed conformation, according to an illustrative embodiment. The telescoping stem 112 has been retracted into the frame 110. The user can swivel the armrests 150 inwards along arrows 804 so that the armrests 150 are approximately parallel with the seat 130. FIG. 8C is a perspective view of a walker in a fully collapsed conformation, according to an illustrative embodiment. The user can press the folding button 108 to unlock the rear supports 114. When the rear supports 114 are unlocked, the user can swing the rear wheels 104 inwards towards the front wheels 102. The walker is in a collapsed conformation and is ready to be stored in a small area. FIG. 8D is a front view of a walker in a fully collapsed conformation, according to an illustrative embodiment.

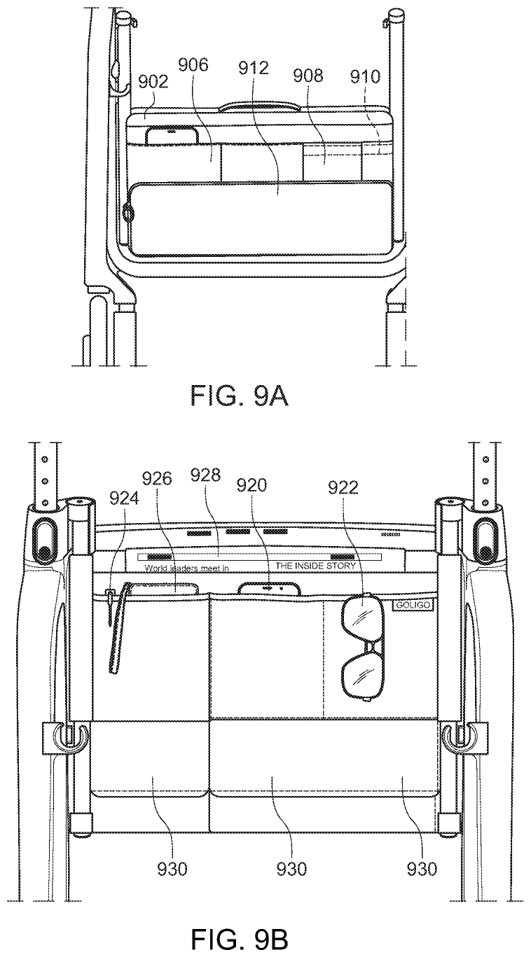

FIG. 9A is a rear view of the bottom of a seat in the stowed position showing storage compartments, according to an illustrative embodiment. A seat 130 can have a variety of pockets and storage areas built into the back of the seat. In various embodiments, the walker can have a magazine or book pocket 902, a cell phone pocket 906, a water bottle pocket 908, a pen pocket 910, and a larger carry-all pocket 912. FIG. 9B is a rear view of the bottom of a seat in the stowed position showing storage compartments with closures, according to an illustrative embodiments. Pockets and storage compartments can be in various arrangements, and can be designed for or used for carrying cell phones 920, sunglasses 922, pens 924, wallets 926, and reading material 928. Various pockets and can have pocket flaps 930 or other closures that can be held closed with Velcro, snaps, magnets, or other means to hold the pocket closed and secure items within the pocket when the seat is moved to a seating conformation.

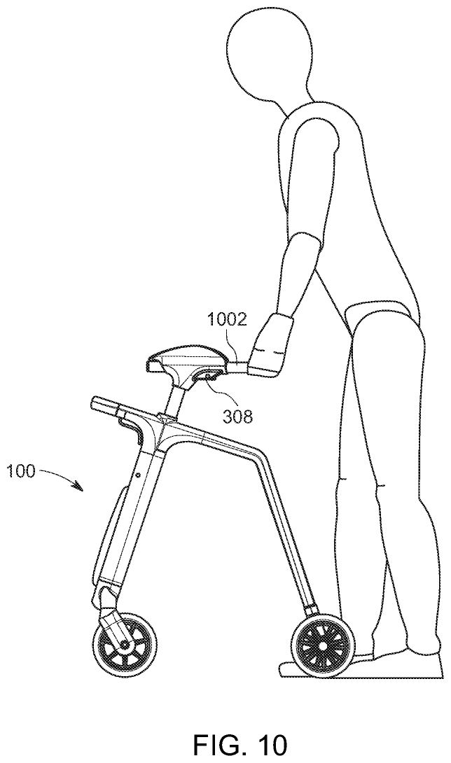

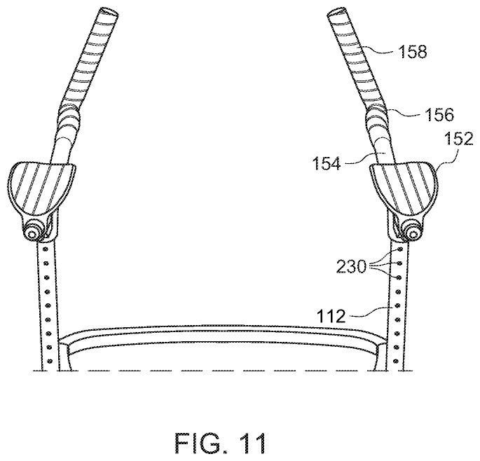

FIG. 10 is a side view showing the walker with an optional straight handlebar, according to an illustrative embodiment. In various embodiments, the curved handlebar can be removed while pressing the push button of the handlebar lock 308 to release the handlebar, and replacing the curved handlebar with a straight handlebar 1002. In various embodiments, the straight handlebar 1002 can replace the standing aid. The optional straight handlebar 1002 can allow the user to walk with the walker in posture associated with a traditional walker.

FIG. 11 is a rear view of a walker showing armrests from the perspective of a user, according to an illustrative embodiment. An armrest can include a cradle 152, handlebar 154, bag hook 156, and handgrip 158. Telescoping stem 112 can have notches 230.

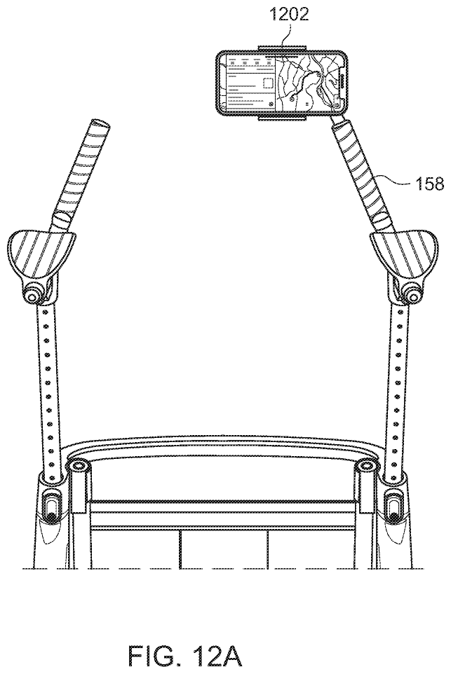

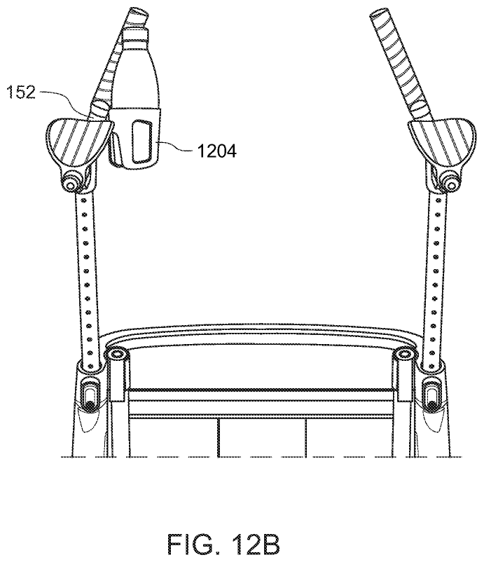

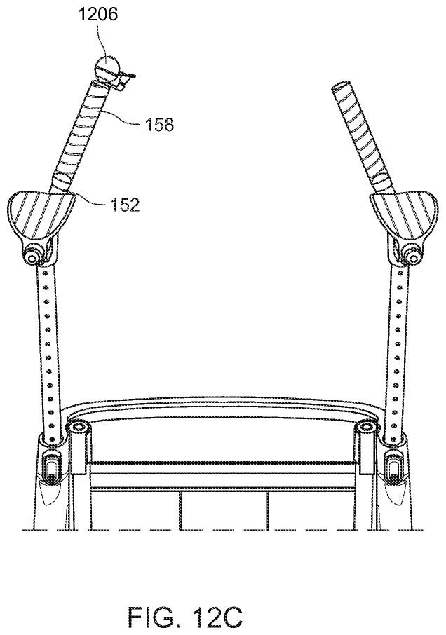

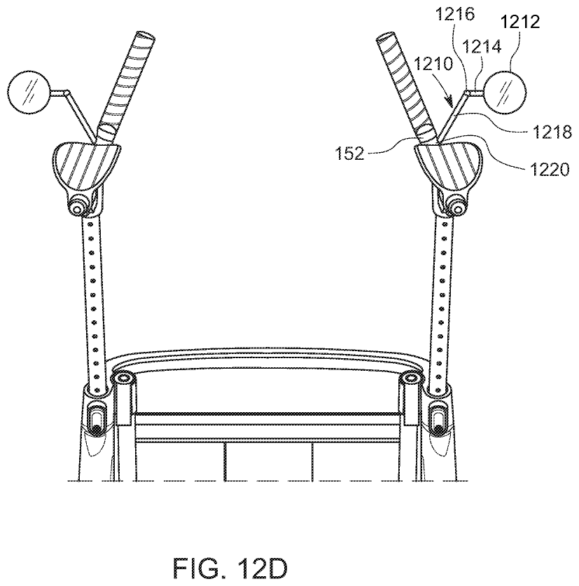

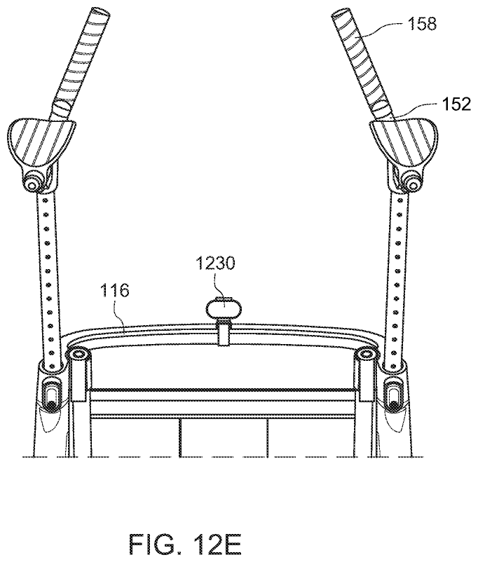

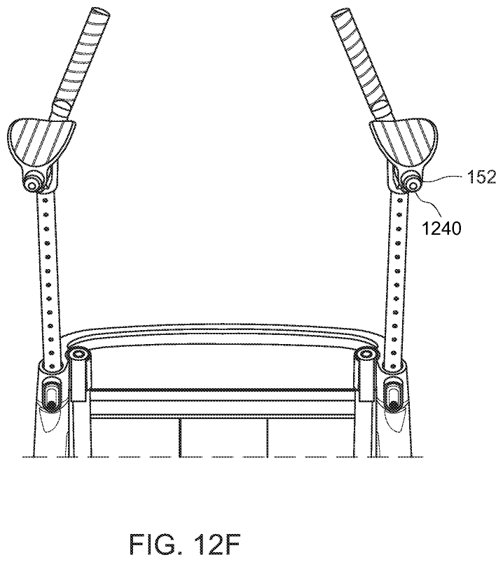

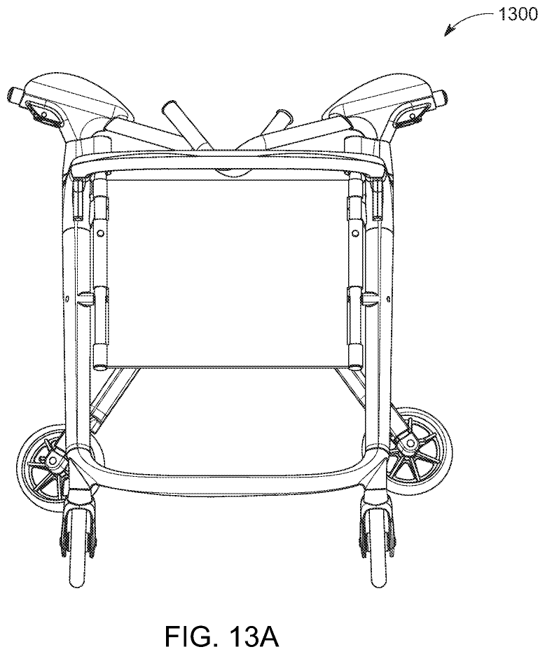

A walker can be customized with many additional features and add-ons that are designed to be used with the walker and can make life easier or more convenient for the user. In general, the depictions herein should be clear to those of skill. The accessories can be implemented using a variety of materials and/or combinations of materials—such as polymers, composites and/or metals. FIG. 12A is a rear view of a walker showing an optional phone holder, according to an illustrative embodiment. A phone holder 1202 can extend from the handlebar 152, including extending from the handgrip 158, to hold a phone in an ideal position for a user to monitor while using the walker, including using phone-based navigation. FIG. 12B is a rear view of a walker showing an optional bottle holder, according to an illustrative embodiment. A bottle holder 1204 can extend from the handlebar 152 to hold a water bottle in a convenient location for the user. FIG. 12C is a rear view of a walker showing an optional bell, according to an illustrative embodiment. A bell 1206 can be mounted to the handgrip 158 so that a user can conveniently ring the bell to get the attention of other people walking in the same area. FIG. 12D is a rear view of a walker showing an optional rear view mirror, according to an illustrative embodiment. A mirror assembly 1210 can include an adjustable mirror 1212 that can be adjustably mounted to a first mirror stem 1214. The first mirror stem 1214 can be adjustably mounted to a second mirror stem 1218 at a first hinge 1216 that can be an articulating hinge. The second mirror stem 1218 can be adjustably mounted to the handlebar 152 at a second articulating hinge 1220. A user can adjust the mirror to see who or what may be approaching from behind the user. FIG. 12E is a rear view of a walker showing an optional headlamp, according to an illustrative embodiment. A headlamp 1230 can be mounted to a backrest 116, a support bar 118, another part of the frame, or a handlebar 152 including the handgrip 158. FIG. 12F is a rear view of a walker showing optional tail lights, according to an illustrative embodiment. A tail light 1240 can be mounted on a rear surface of a walker, including the back of the handlebar 152.

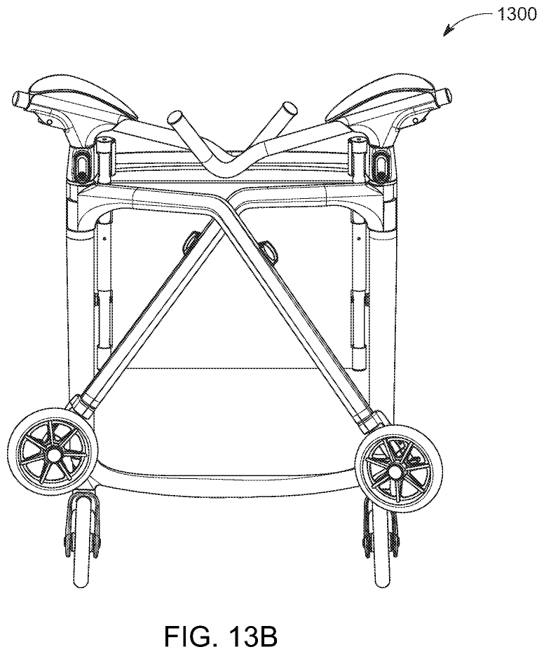

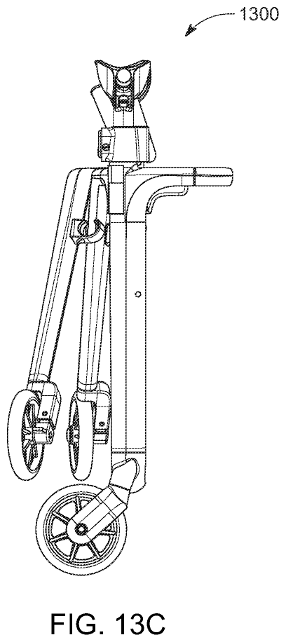

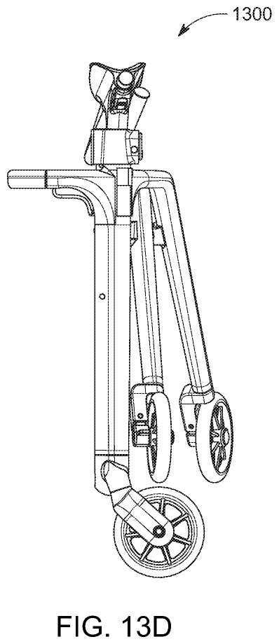

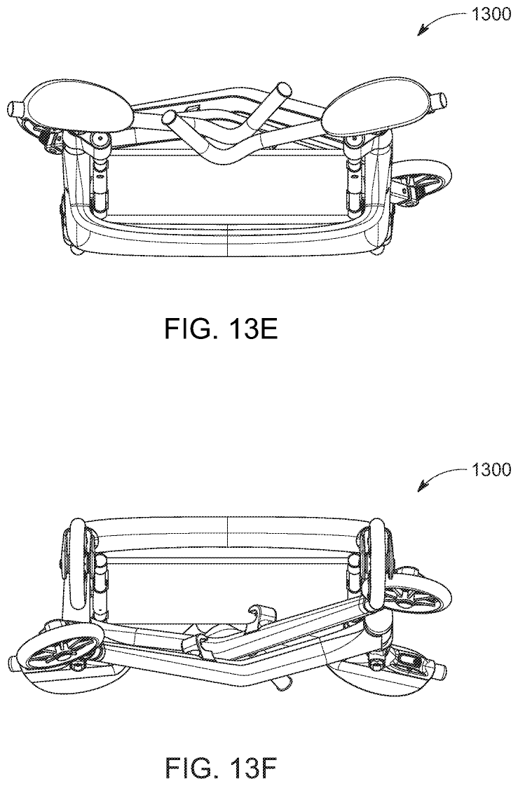

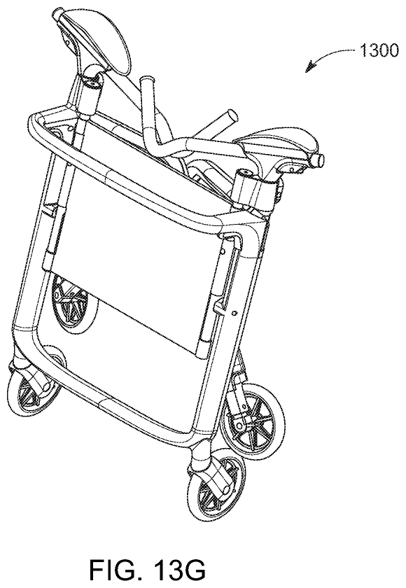

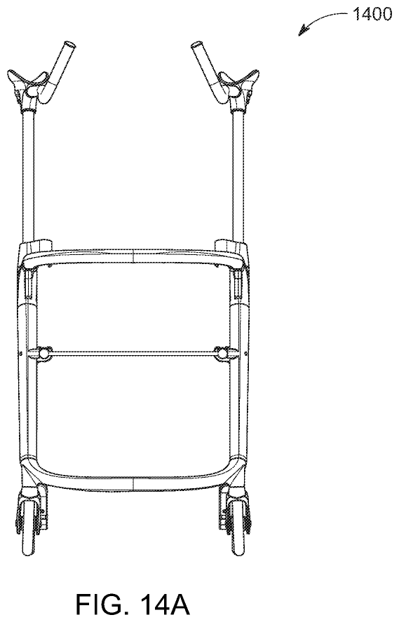

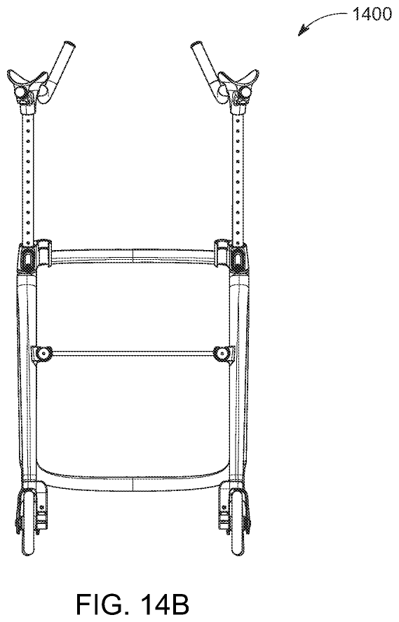

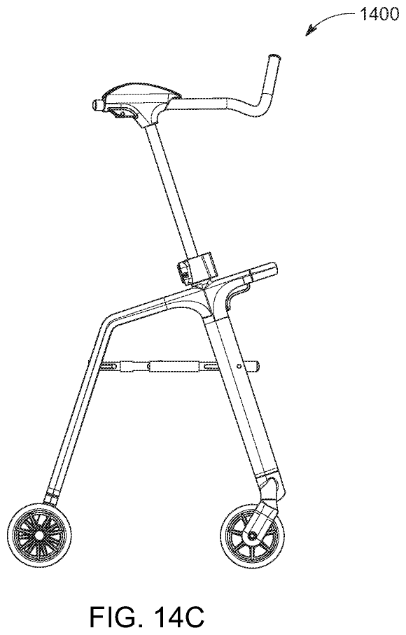

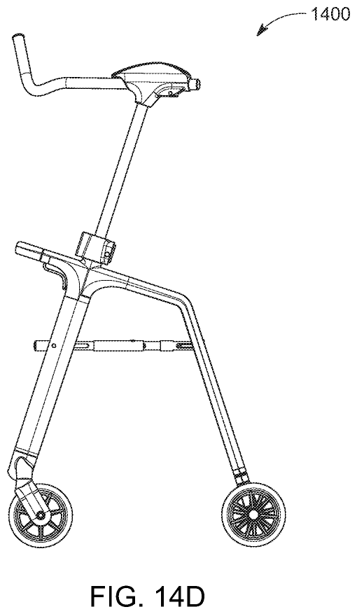

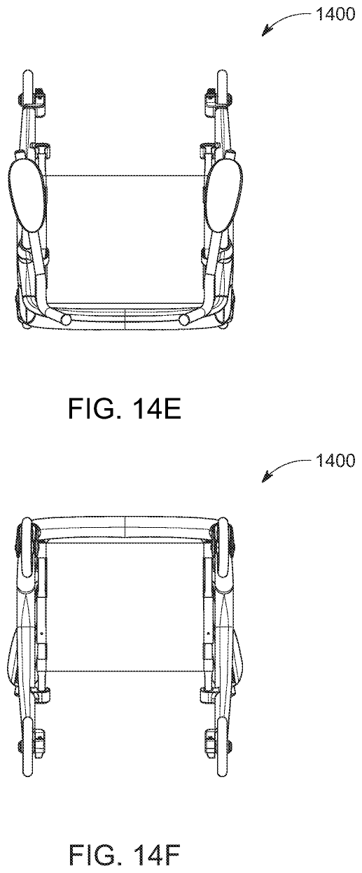

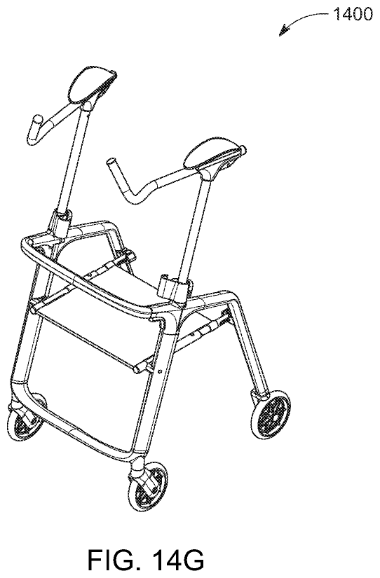

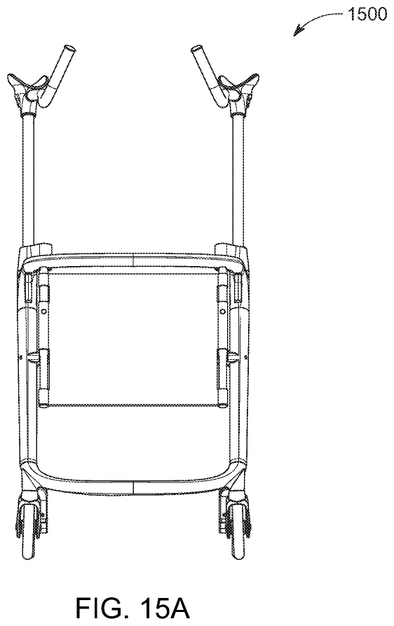

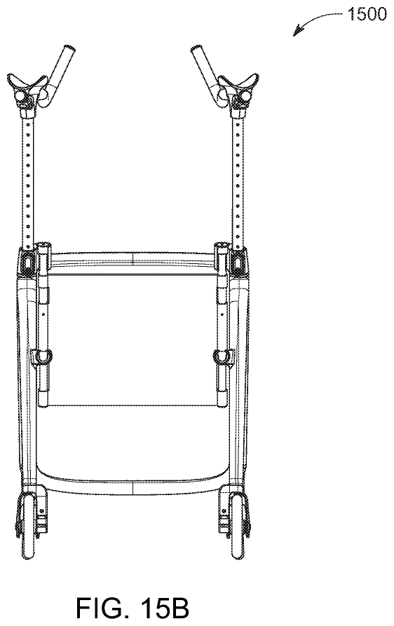

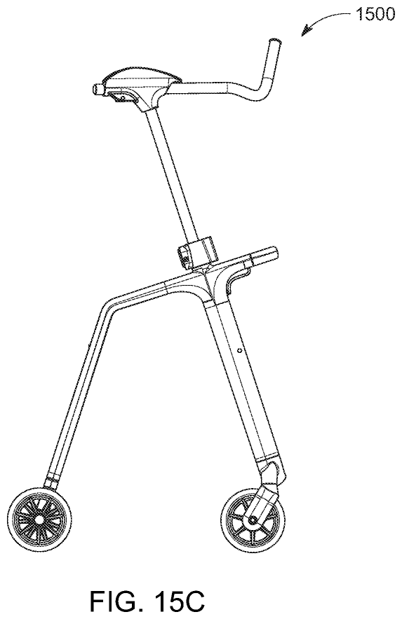

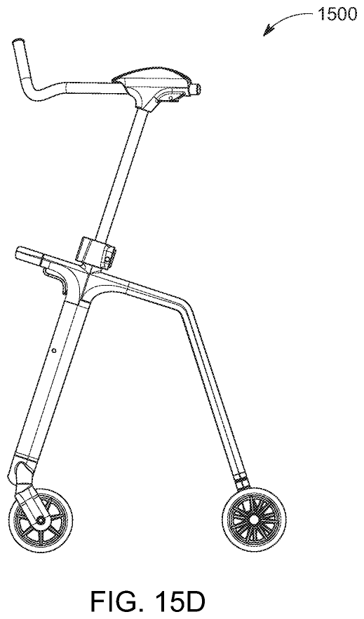

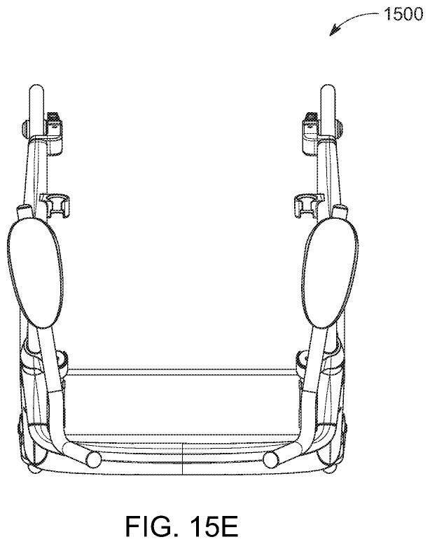

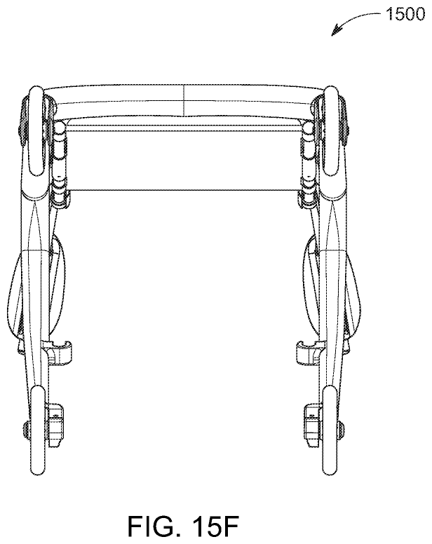

FIGS. 13A-13G are front, back, left, right, top, bottom, and perspective views of a walker 1300 in a collapsed conformation, according to an illustrative embodiment. FIGS. 14A-14G are front, back, left, right, top, bottom, and perspective views of a walker 1400 in a seating conformation, according to an illustrative embodiment. FIGS. 15A-15F are front, back, left, right, top, and bottom views of a walker 1500 in a standing conformation, according to an illustrative embodiment.

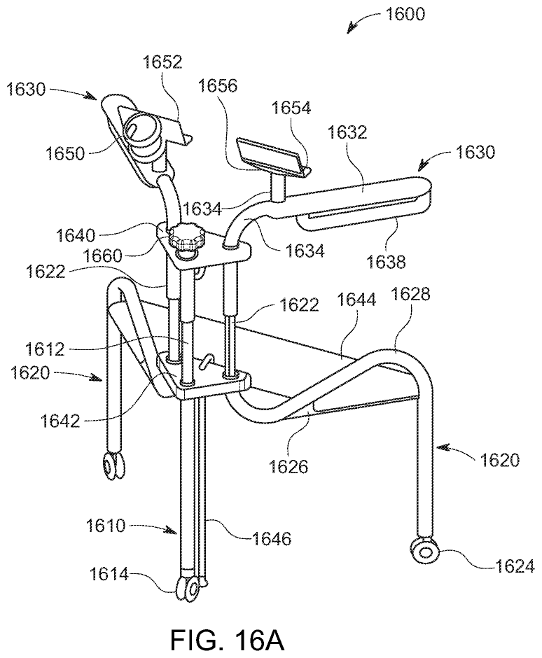

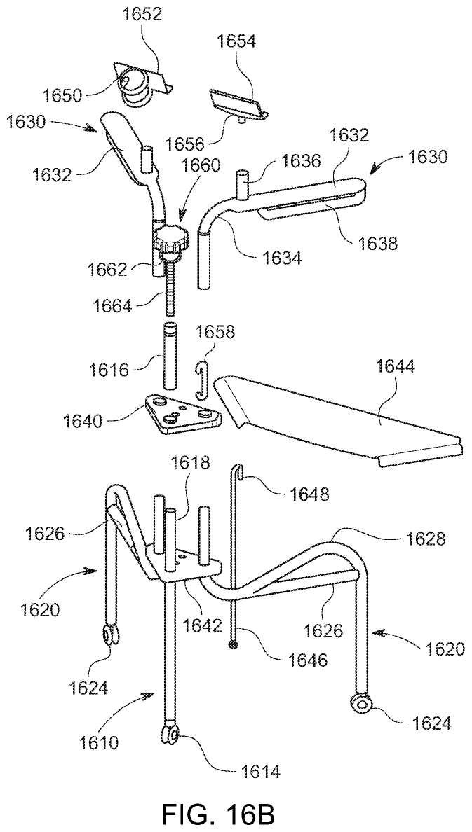

FIG. 16A is a perspective view of a walker with an extendable front leg, according to an embodiment, and FIG. 16B is an exploded perspective view of the walker of FIG. 16A, according to an illustrative embodiment. Turning to FIGS. 16A and 16B, a walker 1600 can have a telescoping front leg 1610, two rear supports 1620, two armrests 1630, an upper support plate 1640 and a lower support plate 1642. Telescoping front leg 1610 is described herein as telescoping, or having two parts with one part sliding within the other, however, it should be clear that other extendable and collapsible arrangements may be possible in various embodiments, including for example, a side-by-side arrangement or other extendable arrangements.

The walker can have a removable seat 1644. A user can sit on the seat when the walker is in the seating conformation, as shown in FIG. 16A, and the user can lift the seat upwards away from the walker for a walking conformation. The walker can have a parking brake 1646 that can prevent the walker from moving as the user sits down and stands up from the walker. The parking brake 1646 can have a hook 1648 at the top that can extend over the edge of the lower support plate 1642 to allow the parking brake 1646 to extend down to the ground in the parked position, as shown in FIG. 16A. A user can lift up on the parking brake 1646 and swivel the top hook 1648 of the brake so that the end of the hook rests on the lower support plate 1642 and the brake is held up and away from the ground in a mobile position. In various embodiments, the brake can click into the braked position and/or the mobile position.

The front leg 1610 can have a front telescoping stem 1612 and a front wheel 1614. The front leg can have a height adjustment control 1660. The height adjustment control 1660 can be a twistable height adjustment knob 1662 with a threaded stalk 1664. The front telescoping stem 1612 can have an upper stem 1616 and a lower stem 1618, and the lower stem 1618 can have threading inside, so that a user can adjust the length of the front telescoping stem by twisting the height adjustment knob 1662 thereby causing the upper stem 1616 and lower stem 1618 to collapse together or extend apart.

The rear supports 1620 can have rear wheels 1624, seat holders 1626 and lower handle 1628. Rear wheels 1624 can be casters that can spin and pivot freely. The walker 1600 can have one or more stabilizing telescoping stems 1622. Stabilizing telescoping stems can be non-weight bearing, or free of a weight bearing role. The rear supports 1620 and the armrests 1630 can be connected by the stabilizing telescoping stems 1622. The stabilizing telescoping stems 1622 can collapse and extend freely as controlled by the state of the front telescoping stem 1612. The stabilizing telescoping stems 1622 can provide rigidity to the walker, preventing the upper support plate 1640 and lower support plate 1642 from twisting relative to each other. In various embodiments, the stabilizing support stem(s) 1622 can connect between the upper support plate 1640 and the lower support plate 1642 in various locations.

The armrests 1630 can have a cradle 1632, a handlebar 1634, and a handgrip 1636. A user can adjust the height of the walker 1600 by twisting the adjustment knob 1662 until the armrests 1630 are at a comfortable position for the user to hold the handgrips 1636 and rest on the cradles 1632 while walking. The height can be adjusted so that the user can stand and walk with good posture. The cradle 1632 can be at an optimal height to support the weight of the user while the user is walking upright and holding the handgrips 1636.

When a user puts weight on the armrests 1630, the weight load is transferred from the armrests 1630 to the upper support plate 1640, the front telescoping step 1612 of the front leg 1610, the lower support plate 1642, and to the rear supports 1620 and rear wheels 1624. The armrest 1630 can be pivotably fixed to the support plate 1640, so that it can pivot within the support plate while also transferring weight to the support plate 1640. The rear support can be pivotably fixed to the lower support plate 1642 so that it can pivot within the lower support plate 1642 while also supporting weight from the lower support plate 1642. The weight of the user can thereby be transferred from the armrests 1630 to the rear wheels 1624.

A user can use the lower handles 1628 and/or the armrests 1630 to push down on the walker to help the user rise from the seated position on the seat 1644 to a standing/walking position. The walker 1600 can have various accessories that can include a cup holder 1650, a mirror 1652, a phone holder/charger 1654, and/or a front light 1656. The walker can include a clamp 1658 that can removably engage with rails 1638 of the armrests 1630 to hold the armrests in a storage conformation, explained more fully below. The clamp can be stored on a support plate or other location when not in use. A user can also attach the seat 1644 to the rails 1638 when the walker 1600 is in a walking conformation, so that the seat 1644 can also be used as a shelf when the walker is in the walking conformation.

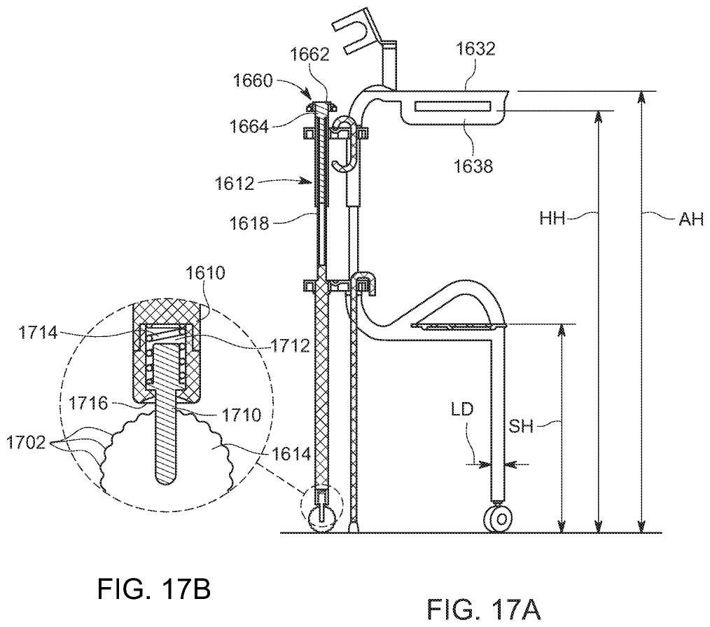

FIG. 17A is a partially cut away view of a walker with a telescoping front leg, showing the inner workings of the telescoping front leg and with dimensions, according to an illustrative embodiment. As shown, threads on the exterior of the stalk 1664 of the height adjustment control 1660 can engage with threads on the interior of the lower stem 1618. A user can extend the front telescoping stem 1612 by twisting the knob 1662.

The armrests can have an armrest height AH from the ground to the top of the cradle 1632 of approximately 44 inches when the armrests are adjusted into a position for a tall user. The rails 1638 can provide a shelf height HH from the ground to the top of the shelf of approximately 42 inches when the walker is adjusted for a tall user. The seat can have a seat height SH from the ground to the top of the seat of approximately 20 inches. The rear support can have a leg diameter LD of approximately 1.25 inches.

FIG. 17B is an enlarged view of the front wheel and braking mechanism shown in FIG. 17A, according to an illustrative embodiment. The front wheel 1614 and rear wheels 1624 can have knurls or other treads 1702 so that the walker can maintain traction on ice or other non-ideal walking conditions. The front wheel 1614 can be attached to a rod 1710 that can slide within a cavity 1712 that can be within the front leg 1610. A spring 1714 can bias the rod 1710 to extend out of the cavity 1712. The bottom of the front leg 1610 can have a brake pad 1716, or spikes to engage the wheel, or other devices to slow or stop the front wheel rom turning. During normal walking conditions the spring biases the rod downwards, thereby maintaining a distance between the front wheel 1614 and the brake pad 1716. If the user shifts weight forward, such as during a stumble, the forward weight will compress the spring, so that the brake presses on the front wheel thereby slowing or stopping the walker until the user can regain balance. The front brake can also automatically lock the walker in place while the user is pushing down on the walker to rise from a seated position to a standing position.

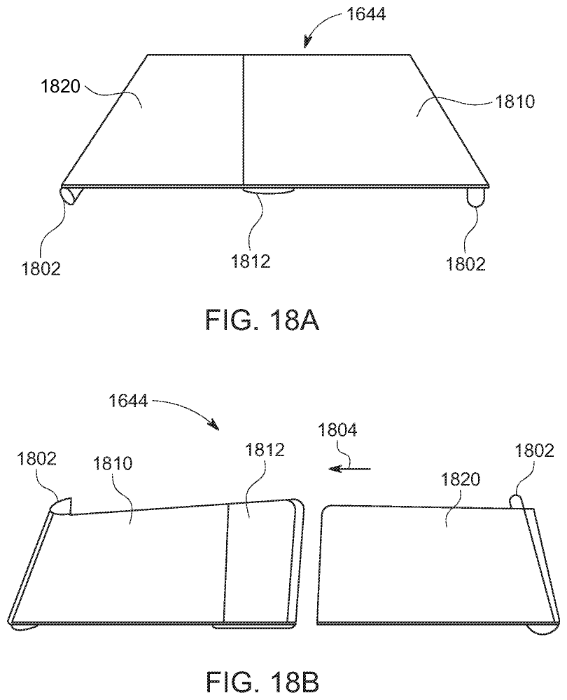

FIG. 18A is a top perspective view of a seat shown in a storage conformation, and FIG. 18B is an exploded bottom perspective view of the seat of FIG. 18A, according to an illustrative embodiment. The seat 1644 can have a lip 1802 on each side of the seat, so that a user can hook the lips around the seat holders to form a seat, or the user can hook the lips around the rails to form a shelf.

A seat 1644 can have a major section 1810 and a minor section 1820. The major section 1810 can have a sheath 1812, and the minor section 1820 can slide within the sheath along arrow 1804, so that the major and minor sections can act as a single unified seat that can support the weight of the user. The user can slide the sections out, then position the seat over the seat holders, and can then slide the sections together so that the lips 1802 engage with the seat holders, thereby holding the seat in place. The user can remove the seat 1644 and slide the major and minor sections together so the seat 1644 can be stored in a compact conformation.

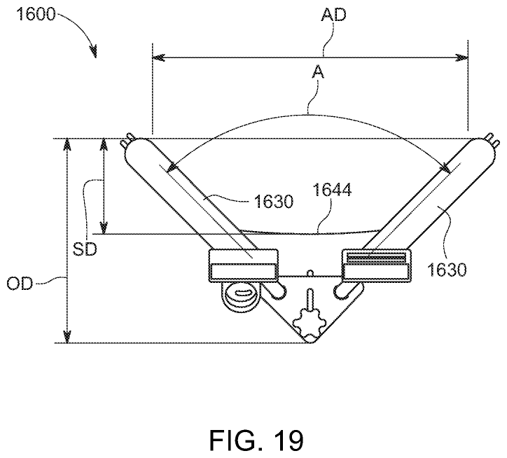

FIG. 19 is a top view of the walker with a telescoping front leg in a seating conformation, and showing dimensions, according to an illustrative embodiment. The armrests 1630 can be at an angle A of approximately 90° relative to each other. The seat 1644 can have a seat depth SD of approximately 9 inches. The walker can have an overall depth OD of approximately 19 inches. The ends of the armrests can have a maximum armrest distance AD between them at their most distant point of approximately 30 inches.

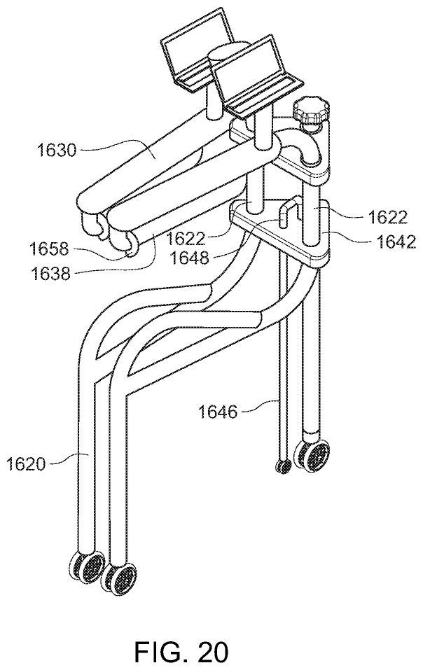

FIG. 20 is a perspective view of the walker shown in a storage conformation, according to an illustrative embodiment. The parking brake 1646 can be lifted up and twisted so that the top hook 1648 rests on the lower support plate 1642. In this position, the parking brake is held up and away from the ground while the user is walking. In the storage conformation, the user can hook the clamp 1658 around the rails 1638 of the armrests to keep the walker in the storage conformation. The stabilizing telescoping sections 1622 can have a non-circular cross section, and can connect the armrests 1630 to the rear supports 1620, so that the armrests 1630 and the rear supports 1620 can be maintained in the same orientation. In this way, the rear supports can be held in the storage conformation by the clamps on the rails 1638 of the armrests 1630.

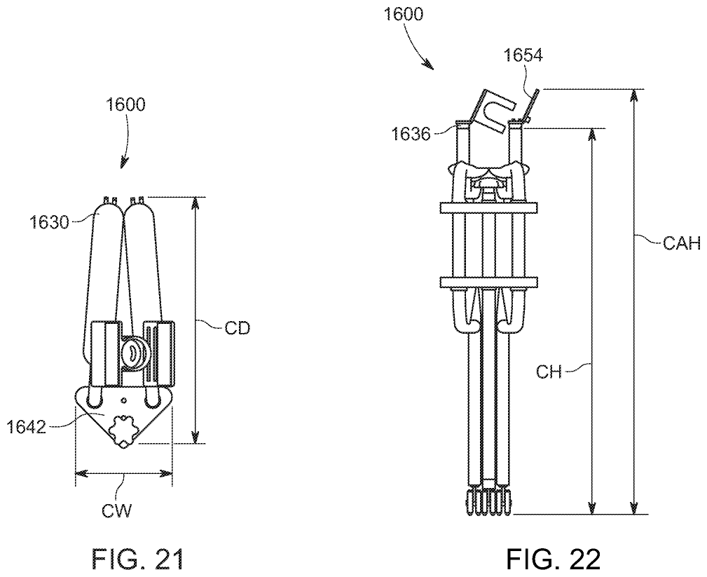

FIG. 21 is a top view of the walker shown in a storage conformation with dimensions, according to an illustrative embodiment. The walker 1600 can have a folded depth CD from the front of the support plate 1642 to the back of the armrest 1630 of approximately 25 inches, and a folded width CW from side to side of approximately 10 inches. FIG. 22 is a front view of a walker shown in a storage conformation with dimensions, according to an illustrative embodiment. The walker 1600 can have a collapsed height CH from the ground to the top of the handgrip 1636 of approximately 39 inches. A walker 1600 with optional accessories such as a cup holder 1650, mirror 1652, phone charger 1654 and/or front light 1656 may have a collapsed accessory height CAH of approximately 44 inches from the ground to the top of the accessory(ies).

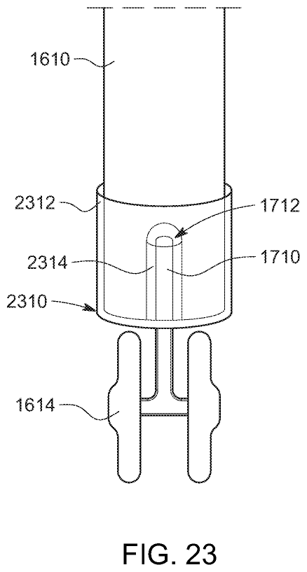

FIG. 23 is a partially cut away view of a front leg and front wheel, showing the inner workings, according to an illustrative embodiment. A front wheel 1614 can be part of a wheel assembly 2310. The wheel assembly 2310 can include a sleeve 2312, and the cavity 1712 that holds the rod 1710 can be formed as part of the sleeve 2312. The cavity 1712 can be defined by a nub 2314 that extends up from the sleeve 2312 into the front leg 1610. The nub 2314 can have external threading and the front leg 1610 can have internal threading, so that the nub 2314 can be threaded into the front leg to secure the sleeve, and the front wheel, to the bottom of the front leg. The nub 2314 and the front leg 1610 can be adjustably engaged by threading the nub further into or out of the front leg 1610. A user can adjust the position of the nub within the front leg to adjust the length of the lower portion of the front leg, and adjusting the length of the lower portion of the front leg can change the height of the seat. The height of the seat can be adjusted approximately three inches by adjusting the position of the nub within the front leg.

Similarly, the rear wheels can be part of a wheel assembly including a nub that threads into the rear supports. The height of the seat can be adjusted by adjusting the position of a nub in the rear support to adjust the length of the rear support.

It should be clear that the walker in various configurations and with various accessories, as described above, provides a lightweight, attractive, easy/comfortable-to-use and convenient-to-fold/store implement for those in need of added support when walking or standing. Various combinations of features described herein are specifically contemplated.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Furthermore, in various embodiments, additional features can be included without departing from the invention, such as the use of a spring to bias an extendable leg upwards and with a locking mechanism to secure the extended leg into place at the desired height. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. An ergonomic walker comprising:
a front leg, the front leg having a front wheel;
at least one support plate;
two rear supports, the rear supports each having a rear wheel, the rear supports rotatably affixed to the at least one support plate; and
two armrests, the armrests rotatably affixed to the at least one support plate.

2. The walker of claim 1, wherein the front leg further comprises a front telescoping stem and a height adjustment control.

3. The walker of claim 2, wherein the at least one support plate further comprises an upper support plate and a lower support plate, and wherein the two armrests are rotatably affixed to the upper support plate, and the two rear supports are rotatably affixed to the lower support plate.

4. The walker of claim 3, wherein the front telescoping stem is between the upper support plate and the lower support plate.

5. The walker of claim 4, wherein the front telescoping stem is weight bearing between the upper support plate and the lower support plate.

6. The walker of claim 3, further comprising one or more stabilizing telescoping stems between the upper support plate and the lower support plate.

7. The walker of claim 6, wherein the one or more stabilizing telescoping stems further comprises two stabilizing telescoping stems, and wherein the stabilizing telescoping stems connect between the armrests and the rear support.

8. The walker of claim 2, wherein the height adjustment control further comprises a knob and a threaded stalk, and wherein the front telescoping stem further comprises an upper stem and a lower stem, and wherein the lower stem is threaded on the inner surface, so that the threaded stalk engages with the threads of the lower stem, so that the height of the armrest can be adjusted by twisting the knob of the front leg.

9. The walker of claim 1, wherein the front leg further comprises a brake on the bottom of the front leg, and wherein the front leg further comprises a rod attached to the front wheel, the rod moving within a cavity of the front leg, and a spring within the cavity that biases the wheel away from the brake.

10. The walker of claim 1, further comprising a parking brake, the parking brake having a hook at the top end, the parking brake passing through the lower support plate so that the bottom end of the parking brake can be off the ground if the hook is turned in a first direction, and the bottom end of the parking brake can be engaged with the ground when the hook is turned in a second direction.

11. The walker of claim 1, wherein each armrest further comprises a cradle adapted for a user to rest forearms on the cradle, and a handgrip adapted for the user to hold by hand.

12. The walker of claim 1, wherein each rear support further comprises a seat holder and a lower handle.

13. The walker of claim 12, wherein each armrest further comprises a support rail, the support rail configured to engage with a lip of the seat, and wherein the seat can be removably affixed to the seat holders as a seat, and can be removably affixed to the support rails as a shelf.

14. The walker of claim 1, wherein the front wheel further comprises a wheel assembly, the wheel assembly including a threaded nub, and wherein the front leg further comprises internal threading, so that the height of the seat can be adjusted by threading the nub into the front leg.

15. An ergonomic walker comprising:
at least one front leg, the at least one front leg having a front wheel;
two rear supports the rear supports having rear wheels;
one or more supports extending between the legs for structural rigidity; and
two adjustable armrests above the walker, the armrests adjustably extendable upwards from a support to different heights above the wheels.

16. The walker of claim 15, wherein the armrests are on a stem that is pivotably affixed to the support, so that the armrests can pivot to different angles relative to each other.

17. The walker of claim 16, wherein each of the armrests further comprise a cradle and a handgrip.

18. The walker of claim 17, further comprising a wheel brake with a spring that biases the wheel away from the brake until a predetermined amount of pressure is applied to push the wheel and the brake into engagement.
